(19) United States
(12) Patent Application Publication
(10) Pub. No.: US 2011/0191221 A1
(43) Pub. Date: Aug. 4, 2011

(54) APPROVAL AND PAYMENT PORTAL

(75) Inventors: Vincent Kubert, Atlanta, GA (US); Alexander Gallo, Atlanta, GA (US)

(73) Assignee: ALEXANDER GALLO HOLDINGS, LLC, Atlanta, GA (US)

(21) Appl. No.: 12/698,673

(22) Filed: Feb. 2, 2010

(51) Int. Cl. G06Q 20/00; G06Q 10/00; G06Q 30/00; G06Q 50/00; G06F 3/00

(52) U.S. Cl. 705/34; 705/30; 705/40; 715/744

(57) ABSTRACT

Methods, systems, and apparatus, including computer programs encoded on a computer storage medium, for web-based portal that facilitates payment approval by a payor and provides selectable payment options to the payee.

### BACKGROUND

This specification relates to a web-based portal that facilitates payment approval by a payor and provides selectable payment options to the payee.

In the last few decades businesses have migrated from using paper documents to electronic documents for nearly every aspect of business. Electronic documents have in large part replaced paper documents because of the ease with which they can be generated, revised, and transmitted. One profession that has nearly completely migrated to the electronic realm is the legal profession. The rise of the Internet, coupled with ever increasing desktop processing capabilities, has transformed nearly every aspect of this profession. For example, much of the legal research is now done on-line, and many court, regulatory or administrative filings are likewise done electronically.

This transformation of the legal profession has likewise caused a similar transformation in legal support services, not only in how the support service providers operate, but also in the scale of their operations. Take, for example, court reporting services for depositions. Today a court reporter service provider can open offices in any geographic location to provide court reporting services. Typically a court reporter will record the deposition transcript and, optionally, arrange for a video record of the deposition to be recorded. Additionally, the court reporter will also collect exhibits provided during the deposition. The court reporter will the upload and/or mail the materials to a central production facility, which, in turn, produces a document collection for the deposition and provides the document collect to the parties to the deposition.

It is often not an effective business practice to employ thousands of court reporters nationwide, however. Accordingly, one business model is designed to allow court reporters to contract with the court reporter service provider on as as-needed basis. Once the court reporter has provided to the court reporter service provider all the materials necessary to generate the document collection, the court reporter is to be paid a fee for his or her services.

Usually the court reporter service provider and court reporter agree to some form of trade credit, e.g., net 30 or net 60, to govern the payment terms. Trade credit terms are typically set by the payee. However, in the case of the court reporter service provider business model, the court reporter service provider is the payor, and the court reporter is the payee. As the court reporter service provider contracts with thousands of court reporters, it is impractical and inefficient to negotiate hundreds, or even thousands, of trade credit terms.

Additionally, the court reporter service provider charges the litigation parties a fee for providing and arranging for court reporting services, and for producing the document collections. The value the court reporter service provider adds is reflected in the difference between what the litigation party pays the court reporter service provider and what the court reporter service provider pays the court reporter. Thus the court reporter invoices should be reviewed against the fees that the court reporter service provider charges to ensure that arrangement with the court reporter is profitable. As there are many court reporters with which the court reporter service provider is contracting, reviewing court reporter invoices for approval can be a daunting task.

### SUMMARY

This specification describes technologies relating to facilitating payment to contractors, e.g., court reporters, in response to the contractor deliveries. The system also provides an approval environment for the payor to ensure job completion, margin, and other quality factors before payment options are made available to the contractor.

In general, one innovative aspect of the subject matter described in this specification can be embodied in methods that include the actions of generating a payment portal environment for displaying invoice data for unpaid invoices and a plurality of payment options for payment each of the unpaid invoices, each of the payment options being unilaterally acceptable by a payee entity associated with the client device, and wherein the payment options include a first payment option that specifies, for a corresponding unpaid invoice, a first net amount to be paid to the payee at an expiration of a net payment term, and a second payment option that specifies, for a corresponding unpaid invoice, a second net amount to be paid to the payee in response to the selection of the second payment option and further to be paid at a time before the expiration of the net payment term, and wherein the second net amount is less than the first net amount; generating, in the payment portal environment, a list of unpaid invoices associated with a user account, the user account specified by a user of the client device; generating, in the payment portal environment, a payment selection option for at least the second payment option for each of the unpaid invoices; generating, in response to a selection of a payment selection option for the second payment option for a corresponding unpaid invoice, express payment data that specifies the corresponding unpaid invoice for which the second net amount is to be paid; and transmitting, from the client device to the account server, the express payment data. Other embodiments of this aspect include corresponding systems, apparatus, and computer programs, configured to perform the actions of the methods, encoded on computer storage devices.

Another innovative aspect of the subject matter described in this specification can be embodied in methods that include the actions of generating a payment approval portal environment for displaying invoice data for unpaid invoices; for each unpaid invoice, generating a listing of invoice data for the invoice; for each unpaid invoice, generating a payment approval option, the selection of which causes the unpaid invoice to be listed in the first client device in response to execution of the first instructions; wherein only unpaid invoices associated with a user account that have been approved by a selection of the payment approval option in the payment approval portal are listed in the payment portal environment.

Particular embodiments of the subject matter described in this specification can be implemented so as to realize one or more of the following advantages. Trade credit terms can be unilaterally accepted by the payee, and the payor can facilitate payment according to the trade credit terms accepted by the payee. The payment approval portal facilitates a quality-based review and approval of invoices before payment. Invoices that have a quality measure below a minimum threshold can be precluded from being approved until a supervisor or administrator grants approval. The review process can help maintain profitability by precluding approval of potentially inaccurate invoices or invoices for which work product was produced inefficiently. The system also provides an approval environment for the payor to ensure job completion, margin, and other quality factors before payment options are made available to the payee on the portal. Vincent—any more advantages?

The details of one or more embodiments of the subject matter described in this specification are set forth in the accompanying drawings and the description below.

### BRIEF DESCRIPTION OF THE DRAWINGS

FIG. 1 is a block diagram of an example document collection and production system.

FIG. 2 is a block diagram of an approval and payment subsystem that is implemented in the production system of FIG. 1.

FIG. 3 is an illustration of a payment approval portal interface.

FIG. 4 is an illustration of a payment portal interface.

FIG. 5 is a flow diagram of an example process for accepting a payment option.

FIG. 6 is a flow diagram of an example process for approval invoices for payment.

FIG. 7 is a block diagram of an example computer system that can be utilized to implement the systems and methods described herein.

Like reference numbers and designations in the various drawings indicate like elements.

### DETAILED DESCRIPTION

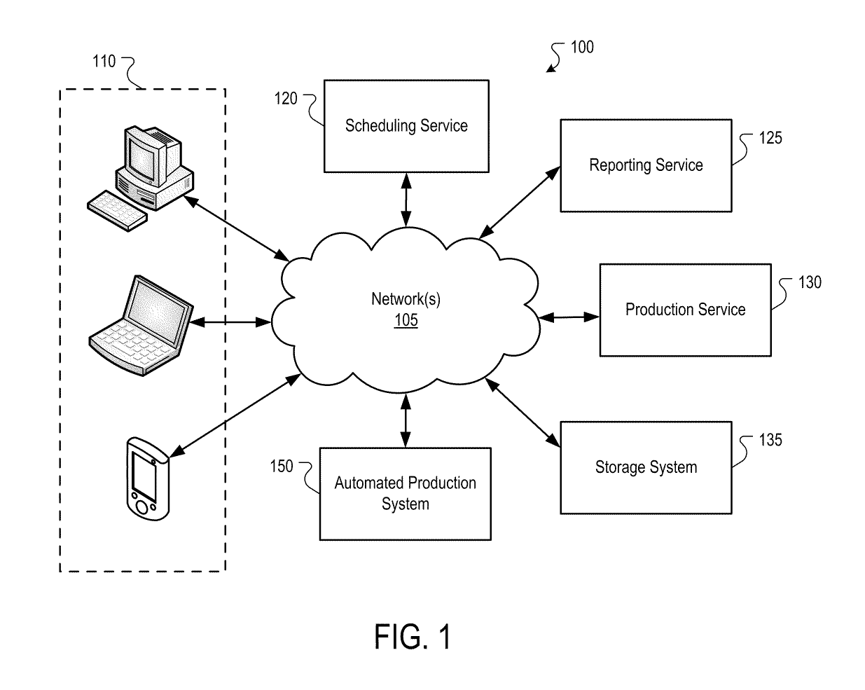

FIG. 1 is a high level block diagram of an example document collection and production system 100 for processing and generating document collections. While the subject matter of this application is described in the context of a document collection and production system 100, the subject matter can be implemented in other systems in which a payee enters into service agreements with multiple payors.

The system 100 permits web-based collection and management of a diverse set of materials (documents and media including audio, images, and/or video), that may be identified and selected for automatic generation of document collections. The system 100 facilitates the scheduling of providers to provide services that result in the production of documents. Examples include scheduling court reporters to provide court reporting services for depositions. The system 100 also permits the production of document collections automatically from a remote user computer, e.g., a computer maintained by the court reporter, with very little involvement of users in physically assembling the reports.

Multiple users of varying degrees of authority can access different features of the system 100. For instance, authorized users (e.g., court reporters) can upload materials (e.g., documents) to the system 100. As another example, authorized users can query a database of documents to create and compile jobs that contain one or more materials to generate a document collection (which as used throughout the present disclosure includes both document and media such as video, audio, and images.) According to yet another example, users may download document collections from the system 100 directly from a web site. Finally, the authorized users can also query an accounting database to view unpaid and paid invoices for which the entity that maintains the system 100 is a payor and the users are payees.

For depositions, the document collections can include materials such as deposition transcripts, indexes of documents, audio recordings of depositions, video of depositions, exhibits, and the like. The system 100 permits the identification of such materials using a simple an intuitive web interface. The interface facilitates scheduling and management of deadlines for the production of document collections, and the uploading of materials for generating document collections. The system 100 can then assemble the document collections with very little user interaction.

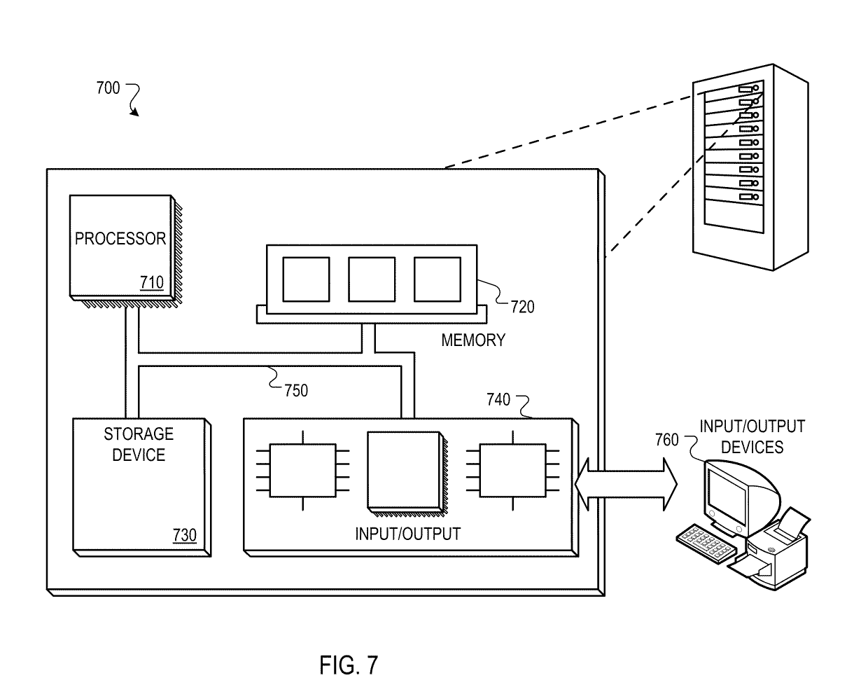

The system 100 generally includes a scheduling service 120, a reporting service 125, a production system, an automated production system 150, a storage system 135, and one or more user computing devices 110. Each of the components 110, 120, 125, 130, 135, 150 can communicate with each other over one or more networks 105, which can include a local area network (LAN), wide area network (WAN), the Internet, or a combination of networks, such as wireless networks in communication with a WAN over a gateway device, for example. An example device (e.g., a computer system component) that can be utilized to implement each of the scheduling service 120, reporting service 125, production service 130, and/or automated production system 150 is shown in FIG. 7 below.

The user devices 110 can, for example, be a computer device including a web browser. Other user devices 110 can also be used, e.g., a mobile communication device. The user devices 110 can, for example, issue web page requests to the scheduling, reporting, and/or production services 120, 125, 130. In response, each of the services 120, 125, 130 can return web page content, e.g. a hypertext markup language (HTML) source document, to the user device 110.

Although described herein as a services, the scheduling service 120, a reporting service 125, a production service 130, and automated production system 150 can include one or more servers having computer instructions thereon for performing the functions described herein. Additionally, although each of the services are illustrated as separate components in FIG. 1, two or more of the services may be combined.

The scheduling service 120 is operable to receive and maintain calendars and schedules of material-generating events. For instance, where the system 100 is employed to generate document collections for depositions, the scheduling service 120 is operable to maintain a calendar of depositions, transmit email reminders regarding depositions, and the like. According to some implementations, when a new job is generated, it is entered into the scheduling service 120 manually, for instance, by an administrator of the scheduling service 120.

The job information that is entered into the scheduling service 120, for instance, by an administrator, can include entities associated with the job, the time the job is to be performed, and like information. Continuing with the example in which the system 100 is employed to generate document collections for depositions, the scheduling service 120 can identify a court reporter to take the deposition. The court reporter will, in response, appear at the deposition to record the disposition, and will then post a transcript and related documents to the system 100 for use in generating document collections.

The scheduling service 120 schedules jobs for completion, and transmits the job information for each job to the production service 130. According to some implementations, the scheduling service 120 can be routinely accessed by one or more other system 100 components, such as the reporting service 125 and/or the production service 130, to identify any new existing jobs. For instance, the production service 130 can access and/or query the scheduling service 120 every 15 minutes to identify if new jobs exist. If new jobs exist, the production service 130 call push the new jobs out to the reporting service 125. Other implementations may exist that permit new jobs in the scheduling service 120 to get pushed or pulled to the reporting service 125.

The scheduling service 120 identifies a particular job by a unique identifier (e.g., a case number) assigned to a job upon creation, along with the job information identifying when materials will be collected and when a consolidated report should be generated based on the collected materials.

The scheduling service 120 can interface with one or more computing platforms and services so that job information can be collected and maintained automatically. For instance, the scheduling service 120 may identify calendar events on one or more user computing devices 110 and/or transmit job information to the one or more user computing devices 110. According to some implementations, the scheduling service 120 can represent a web-based server that permits Internet, LAN, or WAN access by remote authorized users. According to some implementations, clients of the system can review and/or edit scheduled events by communicating with the scheduling service 120.

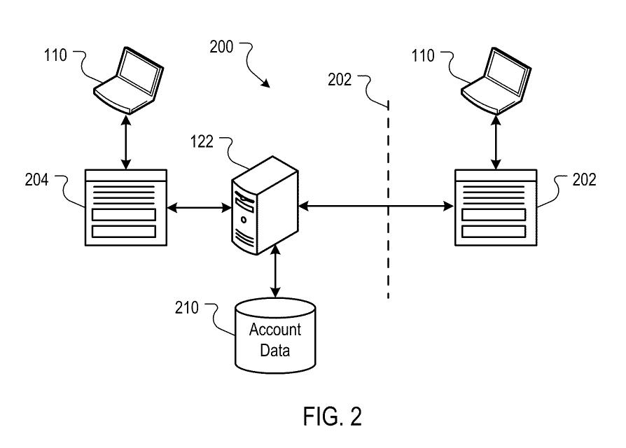

In addition, the scheduling service 120 can include other features, such as a billing system, which is described in more detail in FIG. 2 below. The scheduling service 120 can also be used by one or more of the system components to confirm data associated with a job, such as case numbers, addresses, and the like. In some implementations, if any job information is changed in the scheduling service 120, the new job information will be passed to other components in the system 100 to ensure that the components use up-to-date information. According to some implementations, the scheduling service 120 is routinely queried by other system 100 components to confirm that job information has not changed.

The scheduling service 120 is in communication with a reporting service 125. The reporting service 125 interfaces with the scheduling service 120 and is used to interface with one or more material collecting users. For instance, where the system 100 is employed to generate document collections for depositions, the reporting service 125 may be accessed by one or more court reporters. The reporting service 125 facilitates the uploading of materials to the system 100 such that document collections can be automatically generated with minimal user effort.

Using the reporting service 125 material collecting users, such as court reporters, can view schedules. For instance, court reporters can view schedules identifying when and where depositions are taking place so that the court reporters can accept pending assignments and appear and collect materials (e.g., deposition transcripts) for uploading to the system 100 via the reporting service 125. The reporting service 125 facilitates a fast and secure turn-in of materials, which is advantageous when document collections need to be created quickly. Additionally, as described above, all of the functions of the reporting service 125 may be accessed remotely, such as over the Internet.

The production service 130 is also capable of communication with the scheduling service 120 and reporting service 125. The production service 130 permits the assignment of jobs to production users who are responsible for identifying materials uploaded to the system 100 by clients and material collecting users. The service 130 also aids in the management of jobs by prioritizing jobs and assigning jobs only to authorized users capable of handling the jobs. The production service 130 ensures that all materials necessary to complete a job are identified and provided to the automated production system 150 so that a document collection can be generated.

The storage system 135 stores materials associated with each job. As materials are uploaded to the system, each is stored within the storage system 135. Documents are stored under a specific file name that is based in part on the job number of the document and the type of document that is stored. This naming convention permits the production service 130 to retrieve the files automatically.

The automated production system 150 automatically generates document collections identified by the production service 130. The automated production system 150 can include, among other hardware and software, printers, CD-ROM or DVD-ROM burners, labelers, scanners, and the like. The automated production system 150 is operable to take files identified by the production service 130 and merge them into a consolidated file for printing and/or saving electronically as one file. In particular, the system 150 can collate files on a server (e.g., a server within or comprising the system 150), and can translate diverse files, such as e-transcript files, live notes files, and the like, into a common format such as PDF. Each document is collected and merged into a larger PDF until the system has no more files to merge. Because the files have already been identified by the production service 130, no user entry of file names is required to effect this process.

FIG. 2 is a block diagram of an approval and payment subsystem 200 that is implemented in the system 100 of FIG. 1. The system 200 can be a subsystem of the scheduling service 120 of FIG. 1, or implemented as a separate subsystem. The approval and payment subsystem 200 facilitates approval of invoices for payees (e.g., reporters) by the payor (e.g., a court reporter service provider entity that manages the system 100).

The system 200 includes an account server 122 that can generate first instructions that cause a client device 110 to display a payment portal environment 202, and can also generate second instructions that cause a client device 110 to display a payment approval portal environment 204. Typically, the payment portal environment 202 is used by the payee to view invoices and optionally select one or more payment options for payment of the invoices by the payor. The payment approval portal environment 204 is used by the payor to approve invoices of the payees. As illustrated by the dashed line 202, the approval process occurs within the system 200.

The account server 122 accesses account data 210 during both the approval process and payment process. In operation, after a court reporter has completed a job and turned in materials, an invoice for the court reporter is generated and stored in the accounting data 210. The invoice will reflect an agreed-upon amount the payor agreed to pay the court reporter. This agreed-upon amount can be negotiated for each job, or can be a set fee, or a variable fee depending upon the job parameters.

Invoices are reviewed by an administrator, e.g., an accounting associate of the entity that maintains the system 100, for approval, rejection, or further investigation. Once an invoice is approved, it is made available on the payment portal environment 202 for the particular court reporter with which the invoice is associated. As will be described below, that court reporter may then select one or more payment options to receive payment for the invoice.

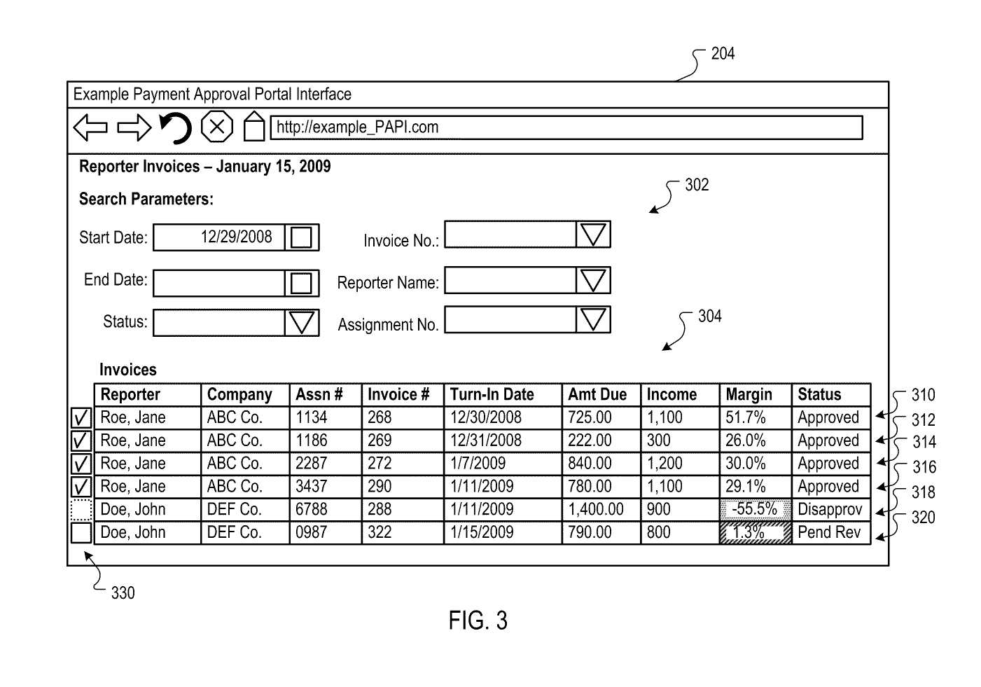

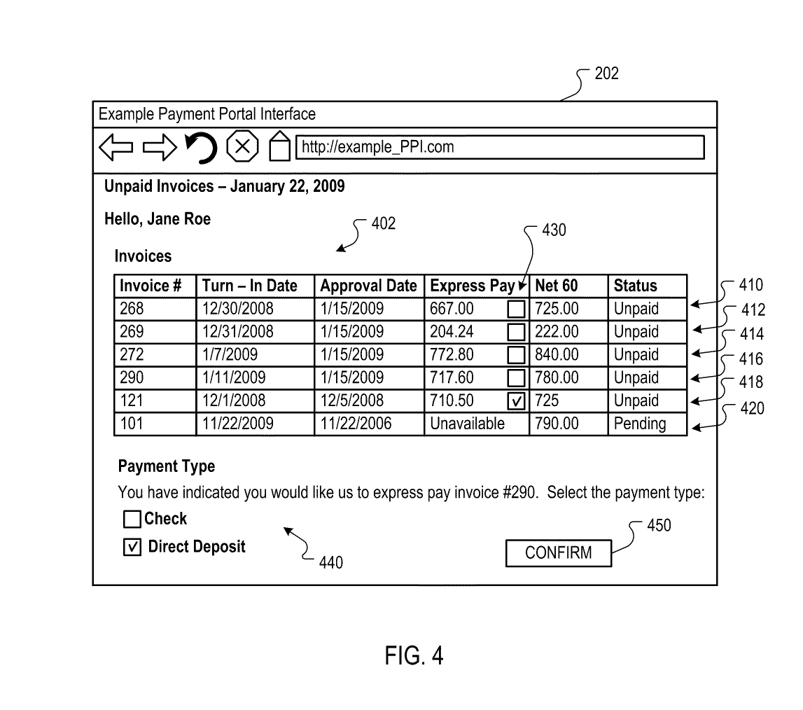

FIG. 3 is an illustration of a payment approval portal interface, and FIG. 4 is an illustration of a payment portal interface 202. Each of these interfaces is described in more detail below.

As shown in FIG. 3, the payment approval portal environment 204 displays invoice data for unpaid invoices. The payment approval portal environment 204 includes a plurality of search input fields 302 and a listing 304 to display invoices that meet search criteria input by use of the search input fields 302.

The listing 304 includes a plurality of unpaid invoices 310, 312, 314, 316, 318 and 320. Each invoice listing includes invoice data, such as a reporter name field, a company name field, an assignment number field, and invoice number field, a turn-in date field, an amount due field, an income field, a margin field, and a status field. More fields can also be included, or fewer fields can be shown.

The reporter name field lists the reporter name, and the company field lists the company name associated with the reporter. The assignment number field lists an internal assignment number that is used by the system 100. The invoice number field lists the invoice numbers of invoices that are under review. The turn-in date field lists the date on which the court reporter provided materials to the system 100, e.g., the date on which the court reporter upload electronic documents to the system 100 for a job associated with the invoice. The amount due field lists the amount due to the reporter. The income field lists the amount the entity that manages the system 100, e.g., the court reporting service that contracted with the court reporter to provide court reporting services, is charging a third party for a reporting services provided by the reporter and the additional document production services and management. The margin field lists the margin with respect to the amount due to the payee, i.e.,

Margin=(Income−Amount Due)/Income

Finally, the status field lists the status of the invoice, e.g., approved, disapproved, pending review.

For each unpaid invoice, a payment approval option 330 is also generated. The selection of the payment approval option by a user causes the unpaid invoice to be listed in the payment portal environment 202 for a payee. Thus, only unpaid invoices associated with the user account that have been approved by a selection of the payment approval option 330 in the payment approval portal interface 204 are shown in the payment portal interface 202.

In some implementations, the margin value in the margin field is used as a quality measurement. In this example, the quality measurement is a measure of payor profit associated with the unpaid invoice. The quality measurement can, in some implementations, be color-coded. For example, a three-color coding scheme can be used, in which quality measurements exceeding a first threshold are color-coded a first color, quality measurements exceeding a second threshold that is less than a first threshold are colored a second color, and quality measurements that are less than the second threshold are color-coded a third color. The first threshold represents a minimum auto-approval quality measure, and the second threshold represents a minimum acceptable quality measure. Quality measures below the second threshold can result in preclusion of invoice approval until a further investigation is made.

For example, with respect to FIG. 3, assume the first threshold is 20% and the second threshold is 0%. As shown in FIG. 3, invoices 310, 312, 314 and 316 have been automatically approved. The user, however, can deselect the payment approval option 330 for each invoice should the user so decide.

The invoice 320, which has a margin of 1.3%, has not been automatically approved, is shown in a color different from the margin values of the auto-approved invoices. The user can, however, manually select payment approval option 330, or optionally investigate why the margin value is so low.

Finally, the invoice 318, which has a margin of −55.5% that is shown in a third color, cannot be approved, as indicated by the phantom payment approval option 330. Here, the user must conduct an investigation as to why the margin is so low as to result in a loss to the court reporter service provider if the court reporter service provider pays the court reporter. For example, the reporter may have entered an incorrect amount due, or the income amounts may not have properly been charged, or any other number of factors may have occurred which resulted in the unacceptably low margin. Once the problems have been investigated, and values possibly adjusted, the invoice may be approved by an account administrator.

As shown in FIG. 4, the payment portal environment 202 displays invoice data for unpaid invoices and a plurality of payment options for payment each of the unpaid invoices. For example, assume the invoices 310, 312 314, and 316 were approved in the payment approval portal interface 204 on Jan. 15, 2009. Thereafter, on Jan. 22, 2009, a court reporter associated with invoice logs into the system 200 to view her outstanding invoices. The payment portal environment 202 includes a list of unpaid invoices 410, 412, 414, 416, 418, and 420. The unpaid invoices 410, 412, 414, and 416 correspond to the recently approved invoices 310, 312, 314 and 316, while the unpaid invoices 418 and 420 correspond to invoices that were approved on Dec. 5, 2008 and Nov. 22, 2008, respectively

Each of the payment options are unilaterally acceptable by the payee (e.g., court reporter) that is using the client device on which the payment portal environment 202 is displayed. In some implementations, the payment options include a first payment option and a second payment option. The first payment option specifies, for a corresponding unpaid invoice, a first net amount to be paid to the payee at an expiration of a net payment term. For example, as shown in FIG. 4, the first payment option is a Net 60 payment option. The second payment option specifies, for a corresponding unpaid invoice, a second net amount to be paid to the payee in response to the selection of the second payment option and further to be paid at a time before the expiration of the net payment term. The second payment option is a second net amount that is less than the first net amount. For example, the express pay amount is the second payment option.

The payment portal environment 202 includes a payment selection option 430 for each of the second payment options of each unpaid invoice. Unless the payment selection option 430 is selected, the payor (e.g., the court reporter service provider) will pay the payee (e.g., the court reported) on the date specified in the first payment option. For example, as shown for invoice 101, a payment of $790 is pending, as Jan. 22, 2010 is the net 60 date relative to the approval date of Nov. 22, 2009. Also, as payment is pending for invoice 101, the express payment option 430 is unavailable for this invoice.

If the payee selects an express payment option, then the client device on which the payment portal 202 is displayed will generate, in response to the selection, express payment data that specifies the corresponding unpaid invoice for which the second net amount is to be paid, and transmit the express payment data to the account server 122. In response to receiving the express payment data, the account server 122 provides for payment by the payor of the second net amount for the unpaid invoice.

For example, the court reporter has selected an express payment of invoice number 121, as indicated by the checkmark in the express payment option 430 for that invoice. Upon the court reporter selecting the confirm 450 button, the client device will generate the express payment data and transmit the express payment data to the account server 122.

In some implementations, each of the payment options is unilaterally specified by the payor entity associated with the unpaid invoices. In other implementations, the payor entity can negotiate specifically with a particular payee, and the payment options can be customized for that payee.

Typically, the second net amount is less than a first net amount, e.g., the second net amount can be a scalar multiple of the first net amount. In some implementations, the scalar multiple can be fixed for the entire period specified by the first payment option; alternatively, the scalar multiple can be fixed for only a portion the period specified by the first payment option. In still other implementations, the scalar multiple is proportional to the difference in time between a current time and the expiration of the net payment term. For example, as shown in FIG. 4, the scalar multiple increases as the date of the net 60 approaches. In other words, the earlier the payee decides to be paid for invoice, a proportionally larger discount is applied to the net 60 payment amount. For example, an express payment of any of the invoices 410, 412, 414 and 416 would result an 8% discount of the net 60 payment amount. Conversely, an express payment of the invoice 121 would result in only a 2% discount of the net 60 payment amount.

In some implementations, the payment portal 202 generates, in response to a selection of a payment selection option for the second payment option for a corresponding unpaid invoice, a payment menu 440 that includes a plurality of payment types. For example, as shown in FIG. 4, the payment types include a wire transfer payment type and a check payment type, and the court reporter has selected the wire transfer payment option. The payment approval portal 202 generates, in response to the selection of one of the payment types, payment type data specifying a payment type of the second net amount by which the payee is to receive funds. The express payment data includes the payment type data, and the accounting server 122 causes the payment to be made in accordance with the selected payment type.

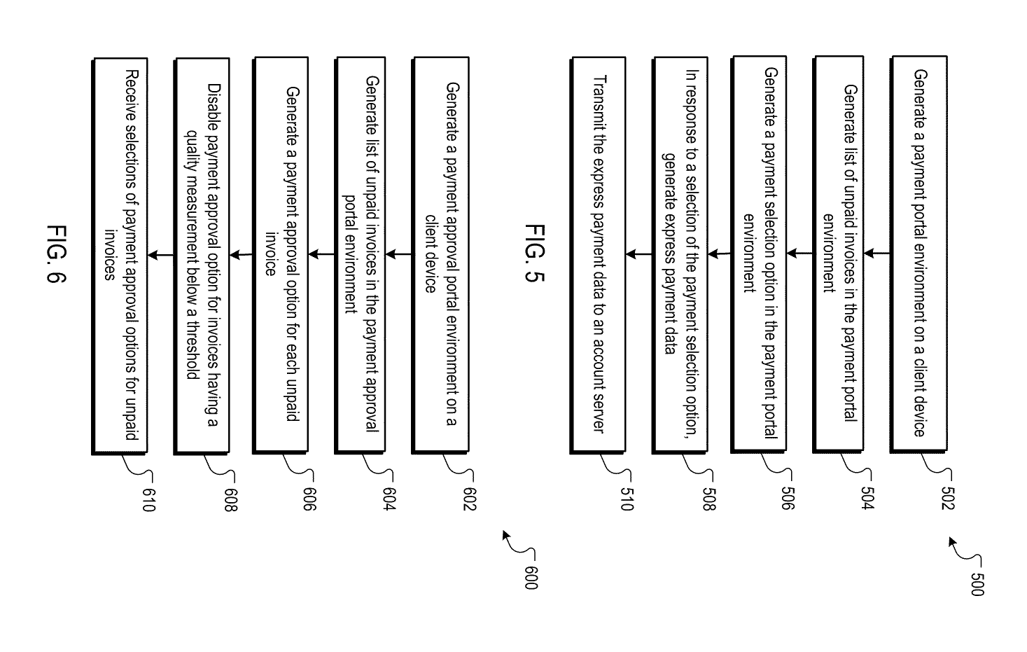

FIG. 5 is a flow diagram of an example process 500 for accepting a payment option. The process 500 can, for example, be implemented on the client device that receives instructions, e.g., HTML instructions, from the account server 122.

The process 500 generates a payment portal environment on a client device (502). For example, the client device 110 can generate the payment portal environment 202.

The process 500 generates a list of unpaid invoices in the payment portal environment (504). For example, the list 402 can be generated in the payment portal environment 202.

The process 500 generates a payment selection option in the payment portal environment (506). For example, the express payment options 430 can be generated in the payment portal environment 202.

The process 500, in response to a selection of the payment selection option, generates express payment data (508). For example, the client device 110 on which the payment portal environment 202 is displayed can generate express payment data as described above.

The process 500 transmits the express payment data to an account server (510). For example, the client device 110 can transmit the express payment data to the account server 122.

FIG. 6 is a flow diagram of an example process 600 for approval invoices for payment. The process 600 can, for example, be implemented on the client device 110 that receives instructions, e.g., HTML instructions, from the account server 122.

The process 600 generates a payment approval portal environment on a client device (602). For example, the client device 110 can generate the payment approval portal 204.

The process 600 generates a list of unpaid invoices for payment approval portal environment (604). For example, the list 304 of unpaid invoices can be generated in the payment approval portal environment 204.

The process 600 generates a payment approval option for each unpaid invoice (606). For example, the payment approval options 330 can be generated in the payment approval portal environment 204.

The process 600 disables payment approval options for invoices having a quality measure below a threshold (608). For example, as shown in the payment approval environment 204, the payment approval option 330 for the invoice 318 is disabled.

The process 600 receives selections of payment approval options for unpaid invoices (610). For example, the payment approval option 330 for the invoice 320 can be selected, and any of the payment approval options for the invoices 310, 312, 314, and 316 can be deselected.

[Vincent: The following boilerplate says the invention can be implemented in all manner of digital computer and circuit technology.]

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

FIG. 7 is a block diagram of an example computer system 700 that can be utilized to implement the systems and methods described herein. The architecture of the system 700 can, for example, be used to implement a computer client, a computer server, or some other computer device.

The system 700 includes a processor 710, a memory 720, a storage device 730, and an input/output device 740. Each of the components 710, 720, 730, and 740 can, for example, be interconnected using a system bus 750. The processor 710 is capable of processing instructions for execution within the system 700. In one implementation, the processor 710 is a single-threaded processor. In another implementation, the processor 710 is a multi-threaded processor. The processor 710 is capable of processing instructions stored in the memory 720 or on the storage device 730.

The memory 720 stores information within the system 700. In one implementation, the memory 720 is a computer-readable medium. In one implementation, the memory 720 is a volatile memory unit. In another implementation, the memory 720 is a non-volatile memory unit.

The storage device 730 is capable of providing mass storage for the system 700. In one implementation, the storage device 730 is a computer-readable medium. In various different implementations, the storage device 730 can, for example, include a hard disk device, an optical disk device, or some other large capacity storage device.

The input/output device 740 provides input/output operations for the system 700. In one implementation, the input/output device 740 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices 760.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method, comprising:
receiving, at a client device, instructions transmitted from an account server to the client device, the instructions executable by the client device and upon such execution by the client device cause the client device to perform operations comprising:
generate a payment portal environment for displaying invoice data for unpaid invoices and a plurality of payment options for payment each of the unpaid invoices, each of the payment options being unilaterally acceptable by a payee entity associated with the client device, and wherein the payment options include:
a first payment option that specifies, for a corresponding unpaid invoice, a first net amount to be paid to the payee at an expiration of a net payment term;
a second payment option that specifies, for a corresponding unpaid invoice, a second net amount to be paid to the payee in response to a selection of the second payment option and further to be paid at a time before the expiration of the net payment term, and wherein the second net amount is less than the first net amount;
generate, in the payment portal environment, a list of unpaid invoices associated with a user account, the user account specified by a user of the client device;
generate, in the payment portal environment, a payment selection option for at least the second payment option for each of the unpaid invoices;
generate, in response to a selection of a payment selection option for the second payment option for a corresponding unpaid invoice, express payment data that specifies the corresponding unpaid invoice for which the second net amount is to be paid; and
transmit, from the client device to the account server, the express payment data.

2. The method of claim 1, wherein each of the payment options is unilaterally specified by a payor entity associated with the unpaid invoices.

3. The method of claim 1, wherein the second net amount is equal to a scalar multiple of the first net amount.

4. The method of claim 3, wherein the scalar multiple is proportional to the difference in time between a current time and the expiration of the net payment term.

5. The method of claim 1, wherein the instructions cause the client device to perform further operations comprising:
generate, in response to a selection of a payment selection option for the second payment option for a corresponding unpaid invoice, a payment menu that includes a plurality of payment types, the payment types including a wire transfer payment type and a check payment type;
generate, in response to the selection of one of the payment types, payment type data specifying a payment type of the second net amount by which the payee is to receive funds; and
wherein the express payment data includes the payment type data.

6. The method of claim 1, wherein a payor is a court reporting scheduling service entity, and the payee is a court reporting entity.

7. A computer-implemented method, comprising:
generating, at an account server, first instructions executable by a first client device and upon such execution by the first client device cause the first client device to perform operations comprising:
generate a payment portal environment for displaying invoice data for unpaid invoices and a plurality of payment options for payment each of the unpaid invoices, each of the payment options being unilaterally acceptable by a payee entity associated with the first client device, and wherein the payment options include:
a first payment option that specifies, for a corresponding unpaid invoice, a first net amount to be paid to the payee at an expiration of a net payment term;
a second payment option that specifies, for a corresponding unpaid invoice, a second net amount to be paid to the payee in response to a selection of the second payment option and further to be paid at a time before the expiration of the net payment term, and wherein the second net amount is less than the first net amount;
generate, in the payment portal environment, a list of unpaid invoices associated with a user account, the user account specified by a user of the first client device;
generate, in the payment portal, a payment selection option for at least the second payment option for each of the unpaid invoices;
generate, in response to a selection of a payment selection option for the second payment option for a corresponding unpaid invoice, express payment data that specifies the corresponding unpaid invoice for which the second net amount is to be paid;
receiving at the account server express payment data from the first client device, the express payment data specifies a first unpaid invoice for which the second net amount is to be paid; and
providing, in response to the received express payment data, payment by a payor entity of the second net amount for the first unpaid invoice.

8. The method of claim 7, wherein each of the payment options is unilaterally specified by the payor entity associated with the unpaid invoices.

9. The method of claim 7, wherein the second net amount is equal to a scalar multiple of the first net amount.

10. The method of claim 9, wherein the scalar multiple is proportional to the difference in time between a current time and the expiration of the net payment term.

11. The method of claim 7, wherein the first instructions cause the first client device to perform further operations comprising:
generate, in response to a selection of a payment selection option for the second payment option for a corresponding unpaid invoice, a payment menu that includes a plurality of payment types, the payment types including a wire transfer payment type and a check payment type;
generate, in response to the selection of one of the payment types, payment type data specifying a payment type of the second net amount by which the payee is to receive funds; and
wherein the express payment data includes the payment type data; and
providing payment by the payor entity of the second net amount for the first unpaid invoice comprises provided the payment by a payment type specified by the payment type data.

12. The method of claim 11, wherein a payor is a court reporting scheduling service entity, and a payee is a court reporting entity.

13. The method of claim 12, further comprising:
generating, at the account server, second instructions by a second client device and upon such execution by the second client device cause the second client device to perform operations comprising:
generate a payment approval portal environment for displaying invoice data for unpaid invoices;
for each unpaid invoice, generate a listing of invoice data for the invoice;
for each unpaid invoice, generate a payment approval option, the selection of which causes the unpaid invoice to be listed in the first client device in response to execution of the first instructions; and
wherein generating the first instructions comprises generating first instructions that cause the client device generate a list of only unpaid invoices associated with the user account that have been approved by a selection of the payment approval option in the payment approval portal for the unpaid invoice.

14. The method of claim 13, wherein the invoice data includes a quality measurement.

15. The method of claim 14, wherein the quality measurement is a profit margin, the profit margin being a measure of payor profit associated with the unpaid invoice.

16. The method of claim 15, further comprising disabling the payment approval option for unpaid invoices having a profit margin below a minimum profit margin.

17. A computer storage medium encoded with a computer program, the program comprising instructions that when executed by data processing apparatus cause the data processing apparatus to perform operations comprising:
generate a payment portal environment for displaying invoice data for unpaid invoices and a plurality of payment options for payment each of the unpaid invoices, each of the payment options being unilaterally acceptable by a payee entity associated with the data processing apparatus, and wherein the payment options include:
a first payment option that specifies, for a corresponding unpaid invoice, a first net amount to be paid to the payee at an expiration of a net payment term;
a second payment option that specifies, for a corresponding unpaid invoice, a second net amount to be paid to the payee in response to a selection of the second payment option and further to be paid at a time before the expiration of the net payment term, and wherein the second net amount is less than the first net amount;
generate, in the payment portal environment, a list of unpaid invoices associated with a user account, the user account specified by a user of the data processing apparatus;
generate, in the payment portal, a payment selection option for at least the second payment option for each of the unpaid invoices;
generate, in response to a selection of a payment selection option for the second payment option for a corresponding unpaid invoice, express payment data that specifies the corresponding unpaid invoice for which the second net amount is to be paid; and
transmitting, from the data processing apparatus to an account server, the express payment data.

18. A computer storage medium encoded with a computer program, the program comprising instructions that when executed by data processing apparatus cause the data processing apparatus to perform operations comprising:
generating, at the data processing apparatus, the instructions executable by a client device and upon such execution by the client device cause the client device to perform operations comprising:
generate a payment portal environment for displaying invoice data for unpaid invoices and a plurality of payment options for payment each of the unpaid invoices, each of the payment options being unilaterally acceptable by a payee entity associated with the client device, and wherein the payment options include:
a first payment option that specifies, for a corresponding unpaid invoice, a first net amount to be paid to the payee at an expiration of a net payment term;
a second payment option that specifies, for a corresponding unpaid invoice, a second net amount to be paid to the payee in response to a selection of the second payment option and further to be paid at a time before the expiration of the net payment term, and wherein the second net amount is less than the first net amount;
generate, in the payment portal environment, a list of unpaid invoices associated with a user account, the user account specified by a user of the client device;
generate, in the payment portal, a payment selection option for at least the second payment option for each of the unpaid invoices;
generate, in response to a selection of a payment selection option for the second payment option for a corresponding unpaid invoice, express payment data that specifies the corresponding unpaid invoice for which the second net amount is to be paid; and
transmitting, from the client device to the data processing apparatus, the express payment data.

19. A system comprising:
a client device; and
a data processing apparatus operable to interact with the device and to generate instructions executable by the client device and upon such execution by the client device cause the client device to perform operations comprising:
generate a payment portal environment for displaying invoice data for unpaid invoices and a plurality of payment options for payment each of the unpaid invoices, each of the payment options being unilaterally acceptable by a payee entity associated with the client device, and wherein the payment options include:
a first payment option that specifies, for a corresponding unpaid invoice, a first net amount to be paid to the payee at an expiration of a net payment term;
a second payment option that specifies, for a corresponding unpaid invoice, a second net amount to be paid to the payee in response to a selection of the second payment option and further to be paid at a time before the expiration of the net payment term, and wherein the second net amount is less than the first net amount;
generate, in the payment portal environment, a list of unpaid invoices associated with a user account, the user account specified by a user of the client device;
generate, in the payment portal, a payment selection option for at least the second payment option for each of the unpaid invoices;
generate, in response to a selection of a payment selection option for the second payment option for a corresponding unpaid invoice, express payment data that specifies the corresponding unpaid invoice for which the second net amount is to be paid; and
transmitting, from the client device to the data processing apparatus, the express payment data.

20. The system of claim 19, wherein the data processing apparatus comprise a server operable to interact with the client device through a data communication network, and the client device is operable to interact with the server as a client.
